(19) United States
(12) Patent Application Publication
(10) Pub. No.: US 2011/0272387 A1
(43) Pub. Date: Nov. 10, 2011

(54) Laser drilling without burr formation

(76) Inventors: Andrea Massa, Berlin (DE); Andreas Oppert, Falkensee (DE)

(21) Appl. No.: 13/098,539

(22) Filed: May 2, 2011

(30) Foreign Application Priority Data
May 4, 2010 (EP) EP10004709

(51) Int. Cl. B23K 26/38

(52) U.S. Cl. 219/121.71

(57) ABSTRACT

A process for making a hole into a substrate by a laser is provided. According to the proposed process, in a first step, at least one intermediate hole is produced into the substrate by at least one laser, the intermediate hole having an intermediate diameter that is smaller than a final diameter of the hole to be made. In a second step, the hole having the final diameter is produced into the substrate by the at least one laser.

### CROSS REFERENCE TO RELATED APPLICATIONS

This application claims priority of European Patent Office application No. 10004709.1 EP filed May 4, 2010, which is incorporated by reference herein in its entirety.

### FIELD OF INVENTION

The invention relates to the laser drilling of components.

### BACKGROUND OF INVENTION

It is prior art to use a laser for producing holes.

The use of a laser involves the percussion and the trepanning.

Particularly when producing holes in metallic substrates, burrs are formed at the bore outlet owing to the evaporation of the substrate material, even when the surface is provided with surface protection.

These burrs have to be removed with additional expenditure, for example by means of grinding. This is time-consuming and may result in damage to a coating which is possibly present.

### SUMMARY OF INVENTION

It is therefore an object of the invention to solve the problem mentioned above.

The object is achieved by the features of the independent claim(s).

The dependent claims list further advantageous measures which can be combined with one another, as desired, in order to achieve further advantages.

### BRIEF DESCRIPTION OF THE DRAWINGS

FIGS. 1, 2, 3, 4 show steps of the process according to the invention,

FIG. 5 shows a turbine blade or vane,

FIG. 6 shows a list of superalloys, and

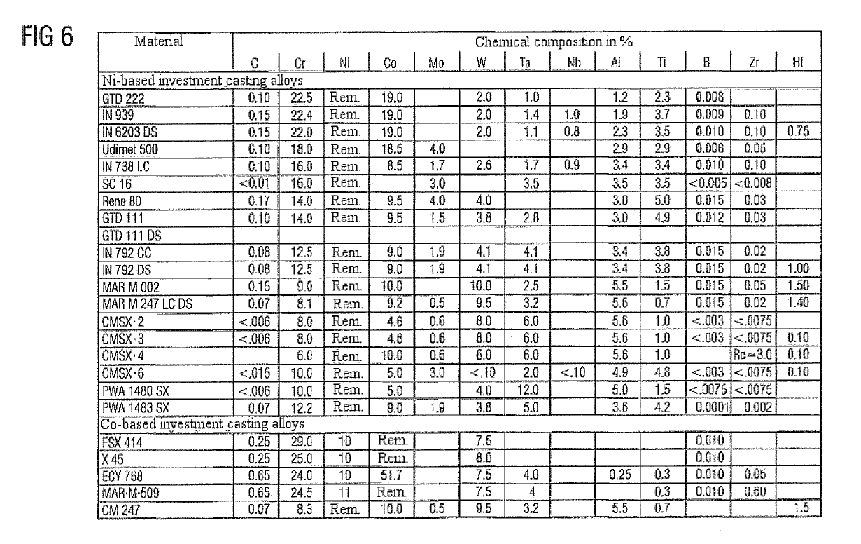

FIGS. 7, 8 show different laser processes.

### DETAILED DESCRIPTION OF INVENTION

The figures and the description represent merely exemplary embodiments of the invention.

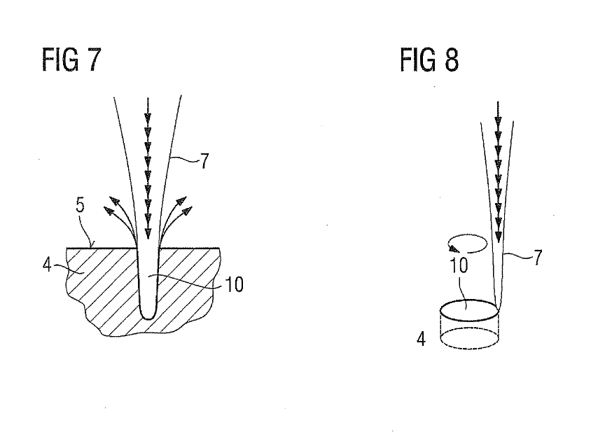

FIG. 7 shows a substrate 4 of a component which is machined by means of a laser beam 7.

Here, the focus is preferably located below the surface 5 of the substrate 4 and the material of the substrate or of the component is evaporated, as indicated by the arrows. In this case, the laser beam does not move within a plane (percussion process), if appropriate perpendicular to the surface 8.

In another laser process—trepanning (FIG. 8)—the laser beam 7 is guided along a desired shape of the hole 10 to be made.

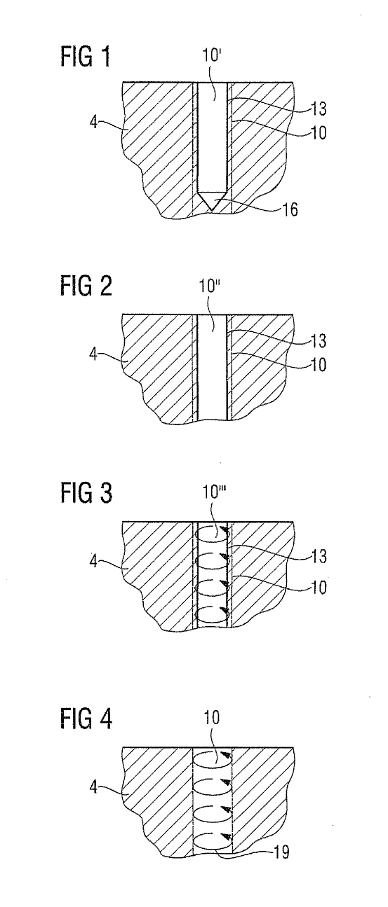

FIG. 1 shows a first step of the process according to the invention.

The percussion process is used to produce an intermediate hole 10′, preferably a blind hole, down to a defined depth, preferably at least 40%, very preferably at least 60%, preferably 90% or 95% of the final drilling depth for a hole 10.

Here, the cross section or the diameter of the intermediate hole 10′ is smaller than the final diameter of the hole 10 to be made. The diameter of the intermediate hole 10′ is preferably smaller than the final diameter by at least 10%. It is preferably 40% to 60% of the final diameter. The energy for making the intermediate hole 10′ must be selected so that it is low and it is preferable to set defocusing of the laser beam into the material.

When making the blind hole, a remnant 16 therefore remains at the end of the blind hole 10′.

In a further step, the hole is broken through by a percussion process and preferably with greater energy (at least 20% higher) in best focus (FIG. 2), preferably without the cross section or diameter of the hole 10′ being changed. This results in a transition through-hole 10″.

Optionally, in a third step, the transition through-hole 10″ can be pre-polished by a trepanning process, and this produces the polished hole 10′″ (FIG. 3).

The radius of the blind hole 10′ or of the transition through-hole 10″ is, preferably 50% of the final radius or cross section of the hole 10 to be made.

In a last step, the hole 10 is finally produced from the transition through-hole 10″ or the pre-polished hole 10′″ by a trepanning process, and the desired final diameter 19 is set (FIG. 4).

The formation of burrs is minimized or avoided by the pre-percussion and by a subsequent trepanning process.

It is possible to use one or a plurality of lasers, in particular for the different laser processes (trepanning, percussion).

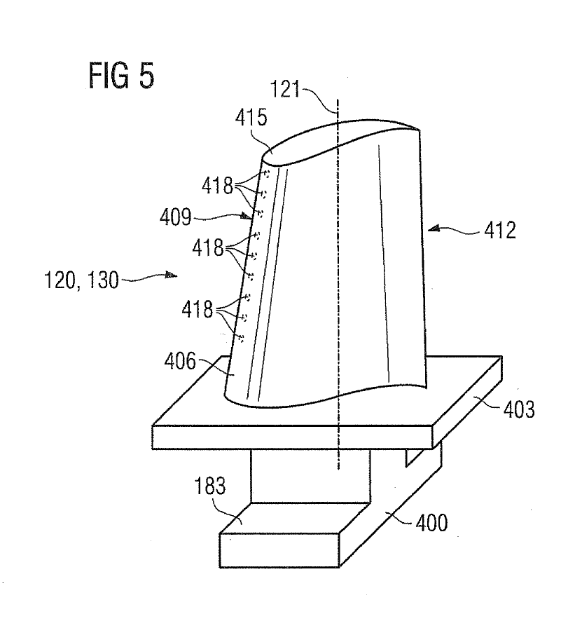

FIG. 5 shows a perspective view of a rotor blade 120 or guide vane 130 of a turbomachine, which extends along a longitudinal axis 121.

The turbomachine may be a gas turbine of an aircraft or of a power plant for generating electricity, a steam turbine or a compressor.

The blade or vane 120, 130 has, in succession along the longitudinal axis 121, a securing region 400, an adjoining blade or vane platform 403 and a main blade or vane part 406 and a blade or vane tip 415.

As a guide vane 130, the vane 130 may have a further platform (not shown) at its vane tip 415.

A blade or vane root 183, which is used to secure the rotor blades 120, 130 to a shaft or a disk (not shown), is formed in the securing region 400.

The blade or vane root 183 is designed, for example, in hammerhead form. Other configurations, such as a fir-tree or dovetail root, are possible.

The blade or vane 120, 130 has a leading edge 409 and a trailing edge 412 for a medium which flows past the main blade or vane part 406.

In the case of conventional blades or vanes 120, 130, by way of example solid metallic materials, in particular superalloys, are used in all regions 400, 403, 406 of the blade or vane 120, 130.

Superalloys of this type are known, for example, from EP 1 204 776 B1, EP 1 306 454, EP 1 319 729 A1, WO 99/67435 or WO 00/44949.

The blade or vane 120, 130 may in this case be produced by a casting process, by means of directional solidification, by a forging process, by a milling process or combinations thereof.

Workpieces with a single-crystal structure or structures are used as components for machines which, in operation, are exposed to high mechanical, thermal and/or chemical stresses.

Single-crystal workpieces of this type are produced, for example, by directional solidification from the melt. This involves casting processes in which the liquid metallic alloy solidifies to form the single-crystal structure, i.e. the single-crystal workpiece, or solidifies directionally.

In this case, dendritic crystals are oriented along the direction of heat flow and form either a columnar crystalline grain structure (i.e. grains which run over the entire length of the workpiece and are referred to here, in accordance with the language customarily used, as directionally solidified) or a single-crystal structure, i.e. the entire workpiece consists of one single crystal. In these processes, a transition to globular (polycrystalline) solidification needs to be avoided, since non-directional growth inevitably forms transverse and longitudinal grain boundaries, which negate the favorable properties of the directionally solidified or single-crystal component.

Where the text refers in general terms to directionally solidified microstructures, this is to be understood as meaning both single crystals, which do not have any grain boundaries or at most have small-angle grain boundaries, and columnar crystal structures, which do have grain boundaries running in the longitudinal direction but do not have any transverse grain boundaries. This second form of crystalline structures is also described as directionally solidified microstructures (directionally solidified structures).

Processes of this type are known from U.S. Pat. No. 6,024,792 and EP 0 892 090 A1.

The blades or vanes 120, 130 may likewise have coatings protecting against corrosion or oxidation e.g. (MCrAlX; M is at least one element selected from the group consisting of iron (Fe), cobalt (Co), nickel (Ni), X is an active element and stands for yttrium (Y) and/or silicon and/or at least one rare earth element, or hafnium (Hf)). Alloys of this type are known from EP 0 486 489 B1, EP 0 786 017 B1, EP 0 412 397 B1 or EP 1 306 454 A1.

The density is preferably 95% of the theoretical density.

A protective aluminum oxide layer (TGO=thermally grown oxide layer) is found on the MCrAlX layer (as an intermediate layer or as the outermost layer).

The layer preferably has a composition Co-30Ni-28Cr-8Al-0.6Y-0.7Si or Co-28Ni-24Cr-10Al-0.6Y. In addition to these cobalt-based protective coatings, it is also preferable to use nickel-based protective layers, such as Ni-10Cr-12Al-0.6Y-3Re or Ni-12Co-21Cr-11Al-0.4Y-2Re or Ni-25Co-17Cr-10Al-0.4Y-1.5Re.

It is also possible for a thermal barrier coating, which is preferably the outermost layer and consists for example of ZrO₂, Y₂O₃—ZrO₂, i.e. unstabilized, partially stabilized or fully stabilized by yttrium oxide and/or calcium oxide and/or magnesium oxide, to be present on the MCrAlX.

The thermal barrier coating covers the entire MCrAlX layer. Columnar grains are produced in the thermal barrier coating by suitable coating processes, such as for example electron beam physical vapor deposition (EB-PVD).

Other coating processes are possible, for example atmospheric plasma spraying (APS), LPPS, VPS or CVD. The thermal barrier coating may include grains that are porous or have micro-cracks or macro-cracks, in order to improve the resistance to thermal shocks. The thermal barrier coating is therefore preferably more porous than the MCrAlX layer.

Refurbishment means that after they have been used, protective layers may have to be removed from components 120, 130 (e.g. by sand-blasting). Then, the corrosion and/or oxidation layers and products are removed. If appropriate, cracks in the component 120, 130 are also repaired. This is followed by recoating of the component 120, 130, after which the component 120, 130 can be reused.

The blade or vane 120, 130 may be hollow or solid in form. If the blade or vane 120, 130 is to be cooled, it is hollow and may also have film-cooling holes 418 (indicated by dashed lines).

1.-11. (canceled)

12. A process for making a hole into substrate by at least one laser, comprising:
in a first step, producing at least one intermediate hole into the substrate by at least one laser, the intermediate hole having an intermediate diameter that is smaller than a final diameter of the hole to be made; and
in a second step, producing the hole having the final diameter into the substrate by the at least one laser.

13. The process as claimed in claim 12, wherein the intermediate hole having the smaller diameter is a blind hole.

14. The process as claimed in claim 13, wherein the blind hole has a depth that is at least 40% of a final depth of the hole to be made.

15. The process as claimed in claim 14, wherein the depth of the blind hole is at least 60% of the final depth of the hole to be made.

16. The process as claimed in claim 12, wherein the intermediate hole having the smaller diameter is a through-hole.

17. The process as claimed in claim 13, further comprising producing a transition through-hole from the blind hole using a second set of production parameters which have been changed compared to a first set of production parameters for the intermediate hole, without changing the diameter of the intermediate hole.

18. The process as claimed in claim 13, further comprising producing a transition through-hole from the intermediate hole by using an energy which is higher than that used for producing the intermediate hole.

19. The process as claimed in claim 18, wherein the energy used for producing the transition through-hole from the intermediate hole is at least 20% higher than that used for making the intermediate hole.

20. The process as claimed in claim 12 further comprising pre-polishing the transition through-hole by a trepanning process.

21. The process as claimed in claim 12, wherein a percussion process is used.

22. The process as claimed in claim 17, further comprising machining the transition through-hole by a trepanning process to produce the hole having the final diameter.

23. The process as claimed in claim 18, further comprising machining the transition through-hole by a trepanning process to produce the hole having the final diameter.

24. The process as claimed in claim 12, wherein the hole to be made is a through-hole.

25. The process as claimed in claim 12, wherein the diameter of the intermediate hole in the first step is at least 10% smaller than the final diameter of the hole to be made.

26. The process as claimed in claim 25, wherein the diameter of the intermediate hole in the first step is at least 40% to 60% of the final diameter of the hole to be made.

27. The process as claimed in claim 13, wherein the depth of the blind hole is at least 90% of the final depth of the hole to be made.

28. The process as claimed in claim 27, wherein the depth of the blind hole is at least 95% of the final depth of the hole to be made.
